(19) United States
(12) Patent Application Publication
(10) Pub. No.: US 2003/0137145 A1
(43) Pub. Date: Jul. 24, 2003

(54) Authentication means

(76) Inventors: John Fell, Cumbria (GB); Rodolphe Van Der Straten, Grune (BE); Gary Power, Melbourne (AU)

Correspondence Address: WENDEROTH, LIND & PONACK, L.L.P., 2033 K STREET N. W., SUITE 800, WASHINGTON, DC, 20006-1021, US

(21) Appl. No.: 10/323,759

(22) Filed: Dec. 20, 2002

Related U.S. Application Data
(63) Continuation of application No. 09/830,124, filed on Oct. 16, 2001, now abandoned.
Application No. 09/830,124 is a 371 of international application No. PCT/EP00/00079, filed on Jan. 7, 2000.
(60) Provisional application No. 60/115,401, filed on Jan. 8, 1999.

(51) Int. Cl. B42D 15/00

(52) U.S. Cl. 283/72

(57) ABSTRACT

An article comprising a substrate having a first portion of transparent plastic and/or cellulosic material, and a security device provided at a second position on the article spaced laterally from the transparent first portion, wherein the transparent first portion includes verification means to verify and/or inspect the security device when the first and second portions of the article are brought into register with one another. The article, which may comprise a label and/or tag, may be used as means for authenticating the origin of high value products.

This application is a continuation of U.S. applictaion Ser. No. 09/830,124, filed Apr. 24, 2001, which is a U.S. National Stage of PCT/EP00/00079, filed Jan. 7, 2000, which claims the benefit of U.S. Provisional Application No. 60/115,401, filed Jan. 8, 1999.

The present invention relates to means for authenticating articles, such as tags or labels which may be attached to such articles, for example to verifying tags or labels which are useful to protect products of substantial value such as software, CDs, video-tapes, clothes, bottles of perfume, wines and alcoholic beverages, automotive parts, aeronautic industry parts and the like. In another aspect the present invention relates to methods for making and verifying the authenticity of a product, use of the authenticating articles, as well as to the authentic products protected by the verifying means of this invention, such as tags or labels.

In recent years, counterfeiting or falsification of valuable products including CDs, bottle of perfumes or automotive parts has proliferated. Security systems for the authentication of such products include tamper proof labels.

U.S. Pat. No. 5,346,259 discloses such kind of tamper proof tag or label wherein the authentication is provided by indicia which can only be seen with the help of a special viewer. This label gets deformed if removed from an article of which the label is placed.

However such labels have a complex structure comprising 8 different layers and are thus difficult to manufacture. Moreover, customers buying the so-protected products are unable to check the authentication indicia, unless they possess the special viewer.

Therefore an aim of the present invention is to provide a safe and easy means, such as verifying tags or labels, in order to protect and authenticate products without the need for a specific apparatus and/or for a complex label structure.

The present invention provides that a transparent window, for example in a security tag or label, may be used as a means for verifying, enhancing and/or optically varying a security device provided elsewhere on for example said tags and/or label and/or for example on a second security tag and/or label.

According to a first aspect of the present invention there is provided an article comprising a substrate having a first portion of transparent plastic and/or cellulosic material, and a security device provided at a second position on the article spaced laterally from the transparent first portion, wherein the transparent first portion includes verification means to verify and/or inspect the security device when the first and second portions of the article are brought into register with one another.

The article, or substantial regions thereof, may be substantially planar and/or sheet-like in construction.

The verification means may comprise a means to verify and/or inspect the security device and the article is shaped and/or can be otherwise positioned so the first and second portions can be in register with one another to permit such verification and/or inspection to take place.

Preferably the verification means comprises one or more of any of the following techniques, seperately, together or in any combination, optionally in corresponding patterns on the first and second portions of the article: Moire inducing pattern, optical lens, Fresnel lens, multiple micro-lens, lenticular lens, distorting lens, metameric ink, micro-printing and polarising filter.

Preferably the article of the present invention comprises a security tag and/or label, in which the verification means comprises a means to verify and/or inspect the security device when the tag and/or label is bent, folded, twisted and/or removed to bring the first and second portions into register with one another.

The article may comprise an integral part of a larger article and/or product (e.g. a high value article whose authenticity it is desired to check). Alternatively the article may comprise for example a label and/or tag which is designed to be or attached to another article and/or for example comprise the packaging associated with another article.

An article of the present invention (in which the article and/or product to which the security article is attached, of which it is an integral part and/or with which it is associated), may preferably be one which would otherwise be susceptible to counterfeiting due to the high value, prestige and/or other importance associated with the article and/or product and/or where authentication of a genuine article and/or product is desired.

Preferably an article of the present invention is selected from at least one from the group consisting of: security tag, label, packaging, brand, trademark, logo, currency note, cheque, share certificate, stamp and official document.

More preferably an article of the present invention is associated with, attached to and/or comprises an article selected from at least one of the group consisting of:

antique objects;

audio and/or visual goods for example blank and/or pre-recorded media in any format (e.g. compact disks, audio tapes and/or video tapes);

chemical products for example pesticides, cleaning products, washing powders and/or detergents;

tobacco products for example cigarettes, cigars, and/or tobacco goods; clothing articles for example leather articles;

soft and/or alcoholic beverages for example wines or spirits;

entertainment goods for example toys and/or computer games;

foodstuffs for example tea, coffee, meats, fish, caviar and/or delicatessen produce,

electrical and electronics parts for example computers and/or spare parts therefor, electronic objects and/or computer software,

high technology machines and/or equipment;

jewellery for example watches;

leisure items for example binoculars and/or telescopes;

perfumes and/or cosmetics for example shampoos, soaps, perfumes, deodorants, body lotions, creams, toothbrushes, toothpastes, razors and/or razor blades;

products related to or for the treatment, diagonsis, therapy and/or propylaxis of humans and/or animals, for example dental, medical and/or surgical equipment, blood transfusion pouches, medical infusion pouches, packaging for donated organs, osmotics bags, personal health equipment (e.g. optical glasses and/or sunglasses) and/or pharmaceutical products (e.g. in any suitable form for application for example pills, tablets, syrups and/or lotions);

military equipment for example guns, gun sights, ammunition, rockets, millitary clothing, foodstuffs, gas-masks, mines, grenades and/or ordinance;

photographic industry goods for example cameras and/or pellicles;

scientific instruments and spare parts therefor, for example microscopes, chromatographic apparatus, spectrometric and/or nuclear magnetic resonance apparatus;

machinery and spare parts for the transport industry for example parts for automotive, aerospace and/or aeronautical industry goods, cars, lorries/trucks, motorcycles, space vechiles, rocket ships, vehicle's windscreen stickers, tax discs, trains, coaches and buses, aeroplanes, tubes, trams, helicopters, deep sea exploration equipment, submarines, ships, boats, liners and/or merchant vessels;

travel goods for example luggage;

security goods, for example cuurency (such as bank-notes), cheques, share certificates, stamps and/or official documents;

sports articles for example sport shoes, tennis rackets, squash rackets and/or equipment for fishing, golf, climbing, skiing, shooting and/or scuba or other deep-sea diving;

any article which has utility in one or more of the uses to which the aforementioned articles may be used, and

any other article which is suitable for attachment to (e.g. as a security label and/or tag) and/or association with (e.g. comprising the packaging) to any of the aforementioned articles.

In a further aspect of the present invention provides a method of manufacturing an product comprising the step of: applying an article of the present invention to a product as an integral part of the product, by attaching or associating the article to the product and/or by associating the article with the product.

In a still further aspect of the present invention provides a method of authenticating a product comprising the steps of:

(a) positioning into register a first and second portion of an article of the present invention, the article being integral to, attached to and/or associated with the product;

(b) observing the verification means in the second portion through the transparent first portion.

A yet further aspect of the present invention provides for the use of an article of the present invention to provide a means of authentication.

A still yet further aspect of the present invention there is provided any product authenticated by an article of the present invention.

According to another embodiment of the present invention, the security label comprises a multi-layered flexible sheet or substrate having a first portion of transparent plastic or cellulosic material, and a security device provided at a second portion of the said sheet or substrate and spaced laterally from the transparent first portion, wherein said transparent first portion includes verification means to verify or inspect the said security device when the label is bent, folded or twisted to bring the first and second portions of the sheet or substrate into register with one another.

As used herein, “transparent” means transmitting rays of light in such a way that the human eye may see through the material distinctly. In particular “transparent” in the context of the present invention means that the second region can be viewed through the first region in a manner sufficient to perform the object of the invention which is to authenticate the article.

A transparent plastic or cellulosic material suitable for carrying out the present invention can be selected from polyolefins, polyesters, regenerated cellulose films, polyethyleneimine, polystyrenes, polyvinylchlorides, polyamides, polyurethanes or acrylics.

The preferred plastic material are biaxially oriented polypropylene and polyesters.

The preferred cellulosic material is regenerated cellulose films. In addition to verifying or inspecting a security device at a laterally spaced location on the same security label, the verifying means may also be used to verify or inspect a security device on another security label, security document or security tag.

According to a second embodiment of the present invention, the security tag or label may be made of a mono-layered substrate.

According to another embodiment of the present invention, there is provided a first security tag or label comprising a sheet or substrate bearing indicia, said first security tag or label having a security device, and a second security tag or label or tag having a portion of flexible transparent plastic or cellulosic material, wherein the transparent plastic or cellulosic material includes verification means to verify or inspect the security device when the second security tag or label is brought into register with said first security tag or label.

According to another embodiment of the invention, there is provided a security label intended to be affixed onto an article, for example, comprising a single flexible sheet formed from a substrate bearing indicia, said sheet having a first portion of transparent plastic material, and also having a security device provided at a second portion of the said sheet spaced laterally from said transparent first portion, wherein said transparent first portion includes verification means to verify or inspect the security device through the article on which said label is affixed, when the first and second portions are into register with one another. Said security label comprises an adhesive layer covering part of one of its surface or its whole surface.

In this embodiment, the security label is preferably formed from a flexible sheet-like substrate of transparent plastic material and/or cellulosic material to which at least one opacifying layer or coating is applied on at least one side of the substrate except in the area(s) where it is desired to provide a transparent, essentially indicia-free, portion or “window” in the security tag or label. This at least one opacifying layer therefore only partially covers the surface of the security label or tag in order to leave said first portion essentially indicia-free.

At least one opacifying layer or coating on either side of the plastic substrate may comprise a paper layer which bears indicia.

Alternatively, in another preferred embodiment, the opacifying layer on either side of the flexible sheet comprises at least one coating of opacifying ink applied to each surface of the transparent plastic substrate. A security tag or label in accordance with the invention can also be formed almost entirely from an opaque paper or laminated substrate construction except in area(s) formed from a transparent plastic material where it is desired to provide window(s) in the security tag or label.

The security tags or labels of all embodiments of the present invention may have any desired shape. In the case of a square or oblong rectangular sheet the first and second portions may be placed in such a way that folding of the flexible sheet about a medium line brings the first and second portions into register. For an oblong sheet having a major axis and a minor axis, the first and second portions may be so disposed that folding of the sheet about a line coincident with or parallel to either the major axis or the minor axis brings the first and second portions into register. Alternatively, the flexible sheet may be folded about a line inclined to the major and minor axes, such as a diagonal line in a rectangular sheet, to bring the first and second portions into register with each other.

Instead of folding the sheet, the flexible sheet may be bent or folded to form a cylinder to bring the first and second portions into register with each other in such a manner that the security device in its second portion may be inspected or verified by viewing through the verification means in its first portion.

In another embodiment of the present invention, the verification means included in the flexible transparent plastic material sheet comprises an optical lens provided in the transparent first portion (or “window”) thereof and the security device provided at the second portion of said sheet comprises a printed, coated, stamped or embossed feature which can be inspected, enhanced or optically varied by viewing through the optical lens of the said verification means or through an optical lens of another similar security tag or label.

A type of optical lens which may be provided in the window of a security tag or label of the present invention is a Fresnel magnifying lens of the type used in overhead projectors. Such a magnifying lens may be formed by coating, stamping, embossing, engraving or otherwise deforming the transparent, indicia-free, plastic portion with concentric circular lines. Another suitable optical lens may alternatively be produced by applying an ultraviolet or otherwise curable varnish or coating onto the “window”, said varnish or coating being then printed with the required structure and made permanent by the curing process. A magnifying lens provided in the window of a flexible security tag or label may be used to enlarge microprinting, a tiny image or a fine line or watermark on another part of the security tag or label or on another similar security tag or label. As an alternative to the Fresnel magnifying lens, a multiple micro-lens array or a lenticular lens array may be used.

It will be appreciated that any other method known to produce optical lens could be used in the present invention.

The verification means included in the flexible transparent plastic material sheet may comprise another type of optical lens, such as a distorting lens, which may be used to distort a security device, feature or image on another part of the security label, or to correct a distorted feature or image on another part of the security label.

In another embodiment of the present invention, the security device provided at the said portion of the flexible transparent plastic material sheet comprises at least an area printed with metameric inks and the verification means comprises an optical filter for viewing the said area printed with metameric inks. The optical filter is preferably arranged to restrict the wavelength distribution of the light that is incident on, and/or reflected from the area printed with metameric inks. This may be achieved by providing a colour tinted optical filter in the transparent essentially indicia-free portion of the flexible sheet. A colour tinted transparent window creates a restricted or altered wavelength environment which is suitable to reveal the colour changing properties of an image printed with metameric inks, thus enabling the authentication of the label to be verified.

In accordance with another embodiment of the invention, there is provided a security tag or label comprising a flexible sheet formed from a substrate bearing indicia, said sheet having an essentially indicia-free portion of transparent plastic material wherein said indicia-free portion (or “window”) includes a colour tinted optical filter for viewing an area printed with metameric inks on the same or a different security label.

The optical filter in the transparent “window” may be produced by various processes, such as, in the first place, including appropriate pigments into a polymer for the production of a plastic film substrate in order to achieve the desired overall tint of said plastic film. In an alternative process, a tinted varnish or coating may be applied over a transparent plastic and/or cellulosic “window” by any printing or coating process.

In accordance with another embodiment of the invention, there is provided a security label comprising a flexible sheet formed from a substrate bearing indicia, said substrate having an essentially indicia-free window of transparent plastic material including verifying means having polarisation characteristics for verifying a security device being a second transparent polarising window or coated window at another location on the same or a different security label.

Polarisation is an optical effect widely used in items such as polarised sunglasses. Light waves from a luminous source vibrate not only in the vertical and horizontal planes but all others in between. Polarisation is an effect whereby the light is confined to one direction only. When a first plane polarised light passes through a second polarising medium whose polarisation axis is at right angle to the first one, then the light intensity drops to nearly zero.

In this embodiment of the present invention, by superimposing a transparent window of security tag or label over a second window of the same or another security tag or label, both windows having selected plane polarisation characteristics, the polarisation property including light extinction will be observed. The second polarising window may be present on the same security tag or label or may be present on a different security tag or label. In each case, the polarisation effect is achieved from the combination of the transparent polarising windows.

When two transparent polarising windows are located at different locations on a single flexible security tag or label, they are preferably constructed and arranged in such a manner that, when the flexible security tag or label is folded over itself to bring the polarising windows into register with each other, the second polarising window has a polarisation axis extending at an angle to the polarisation axis of the first polarising window such that the intensity of light transmitted through the windows is reduced. If the polarisation axes of the first and second polarising windows are substantially perpendicular to one another in the folded security tag or label, the intensity of light transmitted through the windows will be nearly zero.

Such a tag or label with polarising windows according to the present invention may be formed by various methods. First, a transparent plastic substrate or film may be stretched in one direction during manufacture. Alternatively, liquid crystals may be incorporated in a transparent polymeric film which may either form the substrate itself or be coated onto the said substrate.

In another aspect of this invention, the verifying label can be a pressure sensitive label including monoweb, an in-mould label, a wrap-around label, a shrinkable label or a glue-applied label.

In another embodiment of the present invention the verification means of the security tag or label comprises a feature including a first set of lines and the security device comprises a feature including a second set of lines, wherein an interference effect is produced when the security label is bent or folded to bring the verifying means and the security device into register with each other. Preferably, the verifying means and the security device include Moire inducing patterns.

In accordance with another embodiment of the present invention, there is provided a security label comprising a flexible sheet formed from a substrate bearing indicia, said sheet having a first portion of transparent plastic material including verifying means in the form of a Moire inducing pattern for verifying a security device in the form of another Moire inducing pattern at another location on the same or a different security label.

Moire inducing patterns consist of sets of threads or fine lines which produce optically variable effects when a first Moire inducing pattern is superimposed on a second Moire inducing pattern in which the threads or fine lines are inclined at an angle to the threads or fine lines of the first Moire inducing pattern. The transmission of light through superimposed or overlaying sets of inclined lines produces the appearance of dark bands known as “Talbot fringes” which are able to form an image.

In the present invention, a Moire inducing pattern is incorporated into the transparent plastic window of a security tag or label as a verifying security device which, together with another Moire inducing pattern provided at another location in the same security label or in another security label, produces a Moire effect which is readily identifiable to verify the label.

When first and second Moire inducing patterns are provided at two different transversely spaced locations in a single flexible security tag or label, the first and second Moire inducing patterns are preferably arranged in such a manner that, when the flexible security tag or label is folded over itself to bring the Moire inducing patterns into register, the set of lines of the second Moire inducing pattern are inclined to the set of lines of the first Moire inducing pattern.

The set of lines provided in a transparent window to form a Moire inducing pattern may be formed by any convenient printing, coating, stamping, embossing or engraving process.

According to a further embodiment of the present invention, there is provided a method of verifying the authenticity of a product bearing a security label as herein before described, wherein the method comprises the step of bending, folding, twisting or removing the flexible label to bring the first portion including the verifying means into register with the security device provided at the second portion of the label.

Security tag or labels according to the present invention are useful for protecting products of substantial value. A non exhaustive list of such products comprises articles such as: antique objects, audio or visual goods (e.g. compact disks, audio tapes, video tapes . . . ), chemical products (e.g. pesticides, cleaning products, washing powders, detergents), cigarettes and other tobacco products (e.g. cigarettes, cigars, tobacco goods), clothing articles (e.g. leather articles), drinks (soft and alcoholic, e.g. wines, spirits . . . ), entertainment goods (toys, computer games . . . ), foodstuffs (tea, coffee, meats, fish, caviar, delicatessen . . . ), electrical and electronics parts (computers and spare parts, electronic objects, high technology machines and equipment . . . ), jewellery articles (e.g. watches . . . ), leisure items (e.g. binoculars, telescopes . . . ), perfumes and cosmetics (shampoos, soaps, perfumes, deodorants, body lotions, creams, tooth brush, toothpaste, razor.;), health products (dental, medical and surgical equipment, like blood transfusion pouches, medical infusion pouches, packaging for donated organs, osmotics bags, dentistry equipment or personal health equipment like optical glasses, sunglasses..), military equipment (e.g. guns, guns sights, ammunitions, rockets, cloths, foodstuff, gas-mask, mines, grenades . . . ), pharmaceutical products (pills, tablets, syrups, lotions . . . ), photographic industry goods (cameras, pellicles . . . ), scientific instruments and spare parts (microscopes, chromatographic apparatus, spectrometric and nuclear magnetic resonance apparatus . . . ), transportation spare parts (e.g. automotive, aerospace and aeronautical industry goods, cars, lorries/trucks, motorcycles, space shuttle, rocket ships, vehicle's windscreen stickers, tax discs, trains, coaches and buses, aeroplanes, tubes, trams, helicopters, deep sea exploration equipment, submarine, ships, boats, liners or merchant vessels parts . . . ), travel goods (e.g. luggage . . . ), security goods (e.g. stamps . . . ), sports articles (e.g. sport shoes, tennis or squash rackets, fishing, golf, climbing, skiing, shooting or sea-diving equipment . . . ).

Thus a further object of the present invention consists of authentic products protected by at least one verifying tag or label such as described hereinbefore.

Various embodiments of the present invention will now be described, by way of example only, with reference to the accompanying drawings in which:

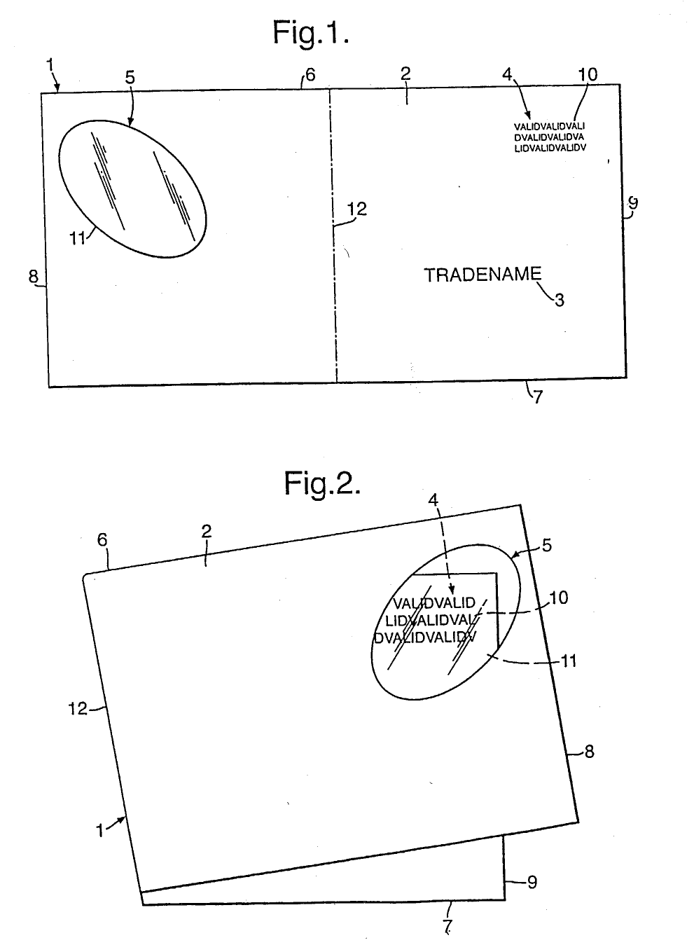

FIG. 1 is a plan view of a label in accordance with a first exemplary embodiment of the invention;

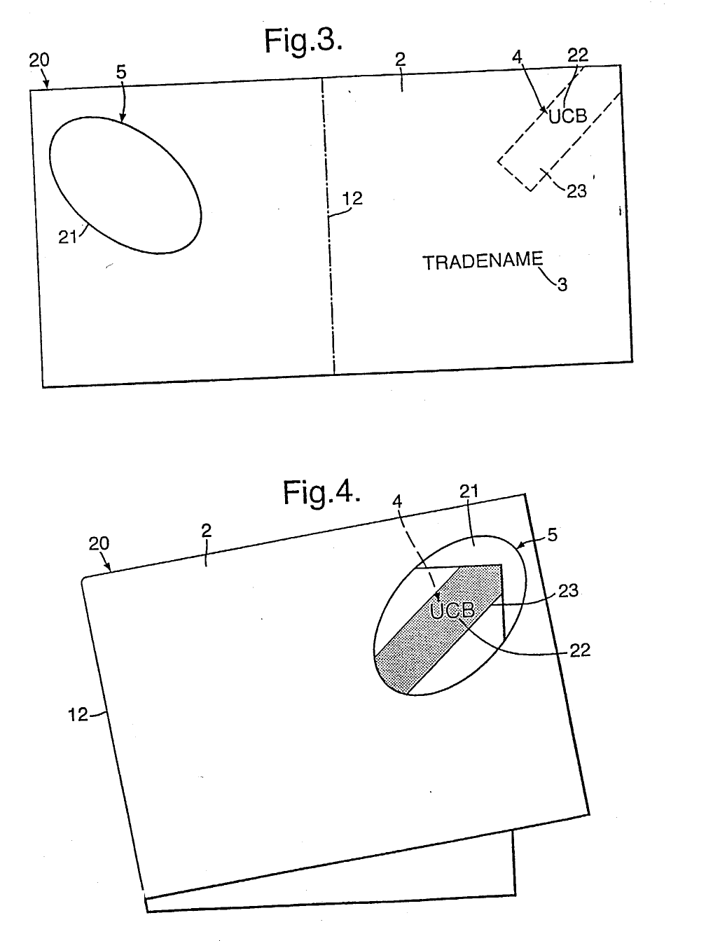

FIG. 2 is a view of the label of FIG. 1 folded over itself, FIG. 3 is a plan view of a label in accordance with a second exemplary embodiment of the invention;

FIG. 4 is a view of the label of FIG. 3 folded over itself,

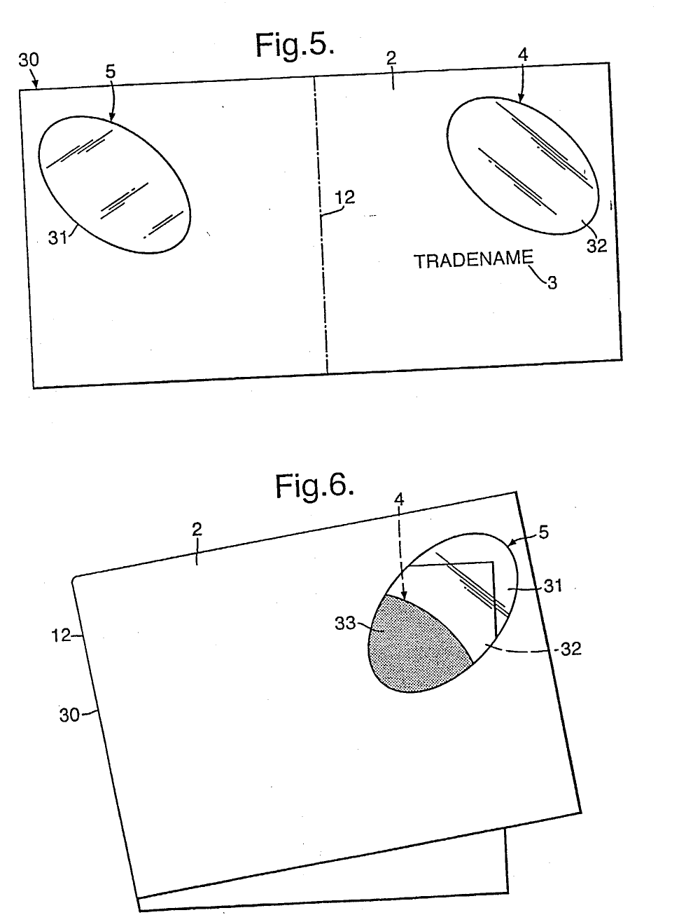

FIG. 5 is a plan view of a label in accordance with a third exemplary embodiment of the invention,

FIG. 6 is a view of the label of FIG. 5 folded over itself;

FIG. 7 is a plan view of a label in accordance with a fourth exemplary embodiment of the invention,

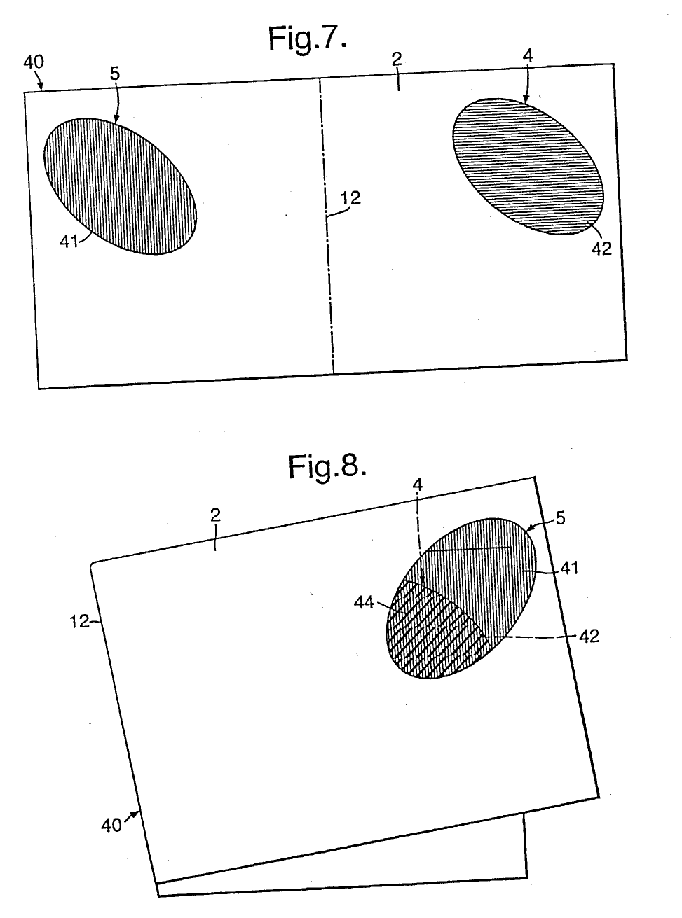

FIG. 8 is a view of the label of FIG. 7 folded over itself,

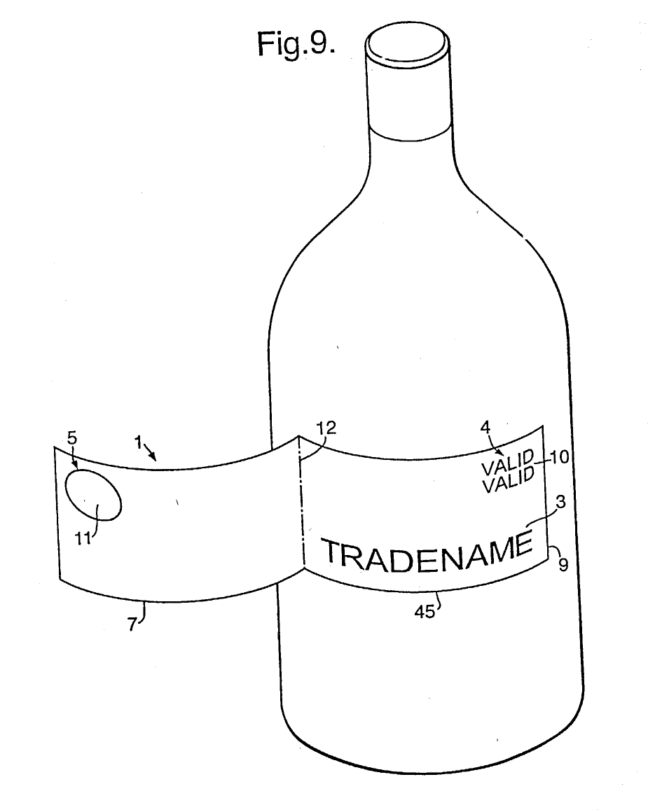

FIG. 9 is a view of the label of FIG. 1 affixed to an article,

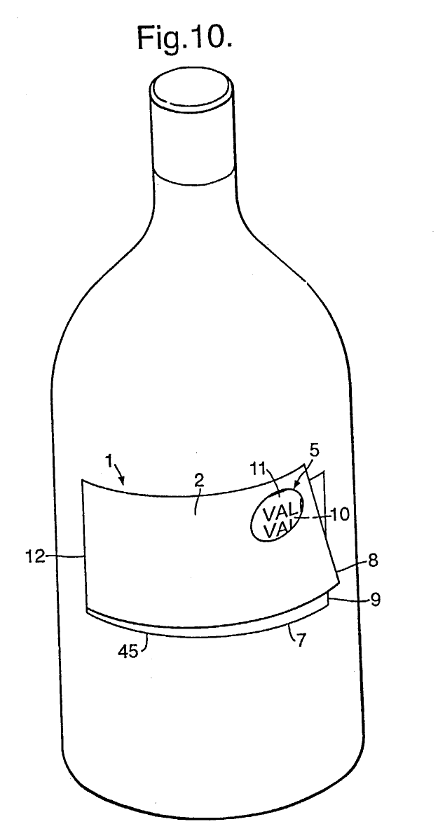

FIG. 10 is a view of the label of FIG. 9 folded over itself,

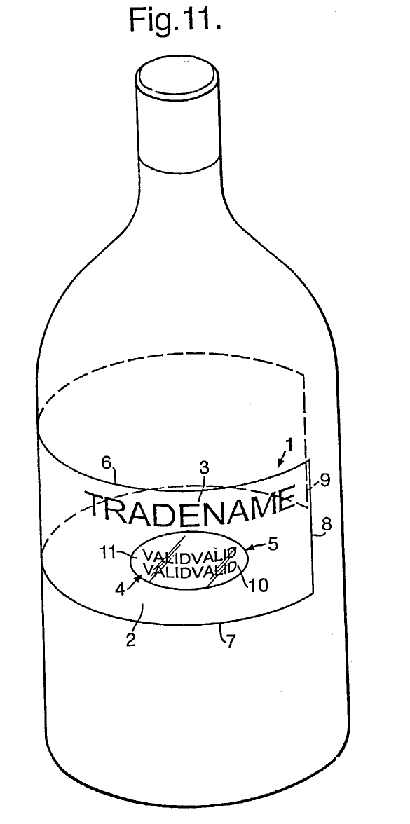

FIG. 11 is a view of the label of FIG. 1 wrapped around an article in accordance with a fifth exemplary embodiment of the invention;

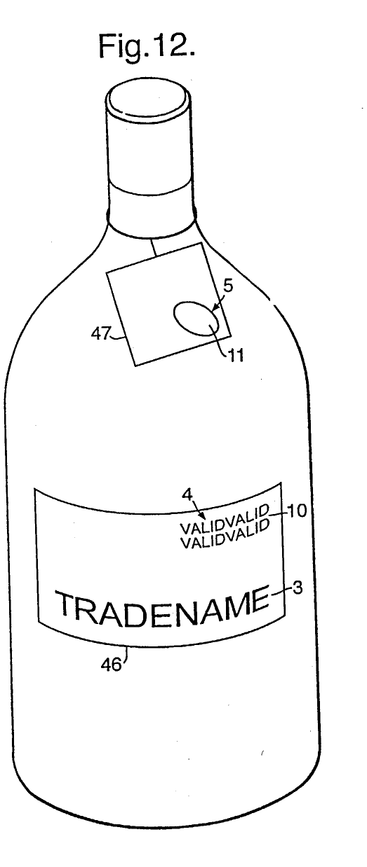

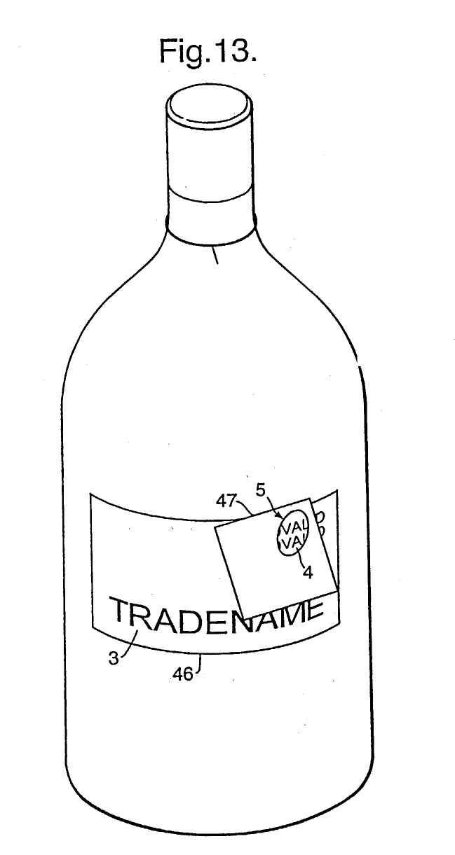

FIG. 12 is a view of a security tag and security label in accordance with a sixth exemplary embodiment of the invention; and

FIG. 13 is a view of the tag and label of FIG. 12 with said security tag used to verify or inspect said security label.

The label 1 shown in FIGS. 1 and 2 is substantially rectangular in shape, having substantially parallel sides 6 and 7 and substantially parallel ends 8 and 9 and comprises a flexible, sheet-like substrate 2 of transparent plastic material bearing indicia 3. The substrate 2 is covered over most of its upper and lower surfaces by opacifying layers. As used herein, the term indicia includes coloured areas, patterns, pictures, shapes, sets of lines, letters, numerals and symbols. For the sake of convenience, the value “TRADENAME” is the only indicia 3 shown in FIG. 1 apart from a security device 4 which comprises an area of microprinting 10 consisting of the word “VALID” repeated several times. Although the word “VALID” is apparent in FIG. 1, the microprinting may be of a size wherein it is not apparent or only barely distinguishable to the naked eye.

As shown in FIG. 1, the opacifying layers of indicia are not applied over the entire surface of the sheet-like substrate 2 and thus leave a transparent portion 5 of the substrate which is at least partially not covered by the opacifying layers. This transparent, essentially indicia-free, portion 5 constitutes a “window” in the tag or label through which light may be transmitted.

The substrate 2 of transparent plastic material is preferably formed from a transparent biaxially oriented polymeric film. The substrate may comprise a single layer film of polymeric material. Alternatively, the substrate may comprise a laminate of two or more layers of transparent biaxially oriented polymeric film of the type described in Australian Patent Specification No. AU A 87665/82, which is incorporated herein by reference.

The opacifying layers of indicia 3 may comprise any one or more of a variety of opacifying inks which can be used in the printing of security labels. For example, the layers of opacifying ink may comprise pigmented coatings comprising a pigment, such as titanium dioxide, dispersed within a binder of cross-linkable polymeric material as described in Australian Patent Specification No. AU A 87665/82. Alternatively, a substrate of transparent plastic material 2 may be sandwiched between opacifying layers of paper to which indicia is printed or otherwise applied. The transparent, essentially indicia-free portion or window 5 is located towards a corner at one end 8 of the rectangular label, and the security device 4 is located towards a corner on the same side 6 and at the opposite end 9 of the label.

In the exemplary embodiment of FIGS. 1 and 2, the transparent, essentially indicia free portion or window 5 includes verifying means in the form of an optical magnifying lens 11. Thus, when the flexible label 1 is folded upon itself generally about a central line 12 extending transversely across the label as shown in FIG. 2, the magnifying lens 11 may be used to view the area of microprinting 10 constituting the security device 4 which appears as an enlarged image. Thus, the security label 1 is self-validating since one part of the label, the magnifying lens 11 in the window 5, may be used to inspect and verify the security device 4, (constituted by the area of microprinting 10), provided at another part of the label 1.

It will also be appreciated that a security tag or label provided with a magnifying lens 11 in a window 5 may also be used to inspect, enlarge and verify microprinting, tiny images or on other security device on another security label.

The magnifying lens may comprise a Fresnel magnifying lens which may be formed by embossing, engraving or otherwise deforming the transparent window 5 to produce a series of concentric circular lines.

The Fresnel lens may be formed in a printing process by an embossing technique. To achieve the required optical refraction it may be necessary to emboss primarily on one side of the film only. If the embossing process embosses both sides of the substrate equally, a coating can be used to fill in one of the embossed surfaces to produce the desired optical lens. The intaglio process is commonly used for embossing, and for a distinctive ink transfer onto labels. The Fresnel engraving design can be embossed into the window under high pressure and temperature in the intaglio process.

Alternatively, a Fresnel magnifying lens can be embossed on the window 5 using a hot stamping technique, more commonly used to transfer optically variable devices onto labels. A magnifying lens may also be produced by applying an ultraviolet or other energy curable varnish or coating which is printed or embossed with the required structure and then made permanent by the curing process.

Referring to FIGS. 3 and 4, there is shown a second exemplary embodiment of a label in accordance with the invention. The label 20 is similar to the label 1 of FIGS. 1 and 2 and corresponding reference numerals have been applied to corresponding parts. The label 20 is therefore substantially rectangular in shape and comprises a flexible, sheet-like substrate 2 bearing indicia 3. The label 20 differs from the label 1 in that the security device 4 comprises an area including a metameric image 22 printed with metameric inks, and the transparent, essentially indicia-free portion or “window” 5 of the substrate 2 includes a verifying means comprising a colour tinted window or “metameric filter” 21.

The security device 4 includes the letters “UCB” which constitute the metameric image 22 formed by printing different parts of the letters with different metameric inks. As shown in FIG. 3, the letters UCB forming the metameric image 22 appear to be exactly the same colour to the naked eye in white light. However, when the label 20 is folded over itself about fold-line 12, a diagonal band 23 extending across the letters 22 and printed with a different metameric ink from the remainder of the letters appears to be a different colour, or at least a different shade of the same colour, when viewed through the metameric filter 21 as shown in FIG. 4. The security device 4 printed with metameric inks may be printed by standard printing techniques. The optical or metameric filter 21 in the transparent window 5 may be provided by including appropriate pigment(s) during the production of the polymeric substrate 2 so that the transparent, essentially indicia-free window 5 in the printed label is colour tinted. Alternatively, a tinted varnish may be applied over a clear, transparent and essentially indicia-free plastic window by a gravure or offset printing process.

In the exemplary embodiment of FIGS. 3 and 4, the use of the transparent plastic window 5 to include an optical or metameric filter 21 which may be used to reveal the colour changing properties of the metameric image 22 on the label provides a verifying label which does not require an external secondary device such as a filter or different lighting source for examining the metameric image to authenticate the label.

It will also be appreciated that a label including an optical or metameric filter in a transparent window, such as the note of FIG. 3, may also be used to examine and verify another label which includes metameric printing or a metameric image as a security device.

A third exemplary embodiment of the invention shown in FIGS. 5 and 6 comprises a label 30 which is generally similar to the label 1 of FIGS. 1 and 2 and again corresponding reference numerals have been applied to corresponding parts. The tag or label 30 differs from the label 1 in that the transparent, essentially indicia-free portion or window 5 of the substrate 2 includes verifying means in the form of a first polarising window 31, and the security device 4 comprises another transparent essentially indicia-free portion in the form of a second polarising window 32.

The first polarising window 31 has a first plane polarisation axis, e.g. parallel to the longitudinal axis of the label 30, and the second polarising window 32 is preferably arranged to have a second plane polarisation axis extending substantially perpendicularly to the first polarisation axis of the first polarising window 31, e.g. extending transversely to the longitudinal axis of the label. Thus, when the label 30 is folded over itself about the fold line 12 to bring the first and second polarising windows 31 and 32 into register, the intensity of light transmitted through both of the polarising windows 31 and 32 is substantially extinct as depicted by the dark shaded region 33 in FIG. 6.

It will, however, be appreciated that the orientations of the first and second plane polarisation axes may vary. For instance, if the first polarising window 31 shown in FIG. 5 has a diagonal first plane polarisation axis extending along the major axis of the elliptically shaped window 3 1, the second polarising window 32 may have a second polarising axis extending substantially parallel to the first polarising axis in the unfolded label shown in FIG. 5, but when the label is folded as shown in FIG. 6, the first and second polarisation axes are substantially perpendicular. Different parts of the polarising windows 31 and 32 may have different polarisation axes so that more interesting optical patterns or effects may be created when the polarising windows are brought into register with each other.

Thus, in the exemplary embodiment of FIGS. 5 and 6, the first and second polarising windows 31 and 32 together form a verifying security device which does not require an external optical device or apparatus to verify the authenticity of the security device. Whilst a label incorporating a first polarising window may be used to verify another polarising window at another part of the label, it may also be used to verify a polarising window on another similar label.

Transparent polarising windows may be produced by different methods. In one possible method, a base film of transparent plastic material may be stretched in one direction during manufacture to produce a differential alignment or orientation of crystals or molecules in the plastic film. In another method, a polymer dispersed liquid crystal (PDLC) film may be used to form a transparent, essentially indicia-free portion or polarising window. A PDLC film is generally characterised by a thin, typically from 10 to 25 micron, film of polymeric material which contains approximately micron sized droplets of a nematic liquid crystal.

Such films may be produced by emulsifying a polymer, water and a liquid crystal mixture, to produce a so-called “nematic curvilinear aligned phase” film. Other methods of producing PDLC films include polymerising a homogeneous solution of liquid crystal and prepolymer. As the resultant polymer forms it causes the liquid crystal to “phase separate”, ideally in the form of discrete droplets. This technique is usually referred to as “polymerisation induced phase separation” and gives rise to PDLC films. Polymerisation may be caused by heat or by ultraviolet light. A PDLC film may either be used as a transparent substrate to which opacifying layers of indicia are applied to form a tag or label, or a PDLC film may be applied as a coating on a transparent, essentially indicia-free portion of the label to form a polarising window.

Referring to FIGS. 7 and 8, there is shown a fourth exemplary embodiment of label 40 in accordance with the invention. The label 40 is similar to the label 30 of FIGS. 5 and 6 and corresponding reference numerals have been applied to corresponding parts. The label 40 differs from the label 30 in that instead of polarising windows, the first transparent, essentially indicia-free portion or window 5 includes verifying means in the form of a first Moire inducing pattern 41 consisting of a set of closely spaced, fine lines, and that the second transparent essentially indicia-free portion or window 4 includes a security device in the form of a second Moire inducing pattern 42 also consisting of a set of closely spaced, fine lines.

As shown in FIG. 7, the fine lines of the first Moire inducing pattern 41 extend substantially parallel to each other in a transverse direction across the label 40, and the fine lines of the second Moire inducing pattern extend substantially parallel to each other in the direction of the longitudinal axis of the label 42. Thus, when the label 40 is folded over itself about the fold-line 12 to bring the first and second windows 4 and 5 into register to each other and the superimposed Moire inducing patterns 41 and 42 are viewed in transmitted light, a series of dark bands known as Talbot fringes 44 are produced which, in the folded label shown in FIG. 8 extend diagonally. The fringes 44 may render the first and second Moire inducing patterns 41 and 42 largely indistinguishable. Alternatively, the fringes may enhance the Moire inducing patterns, creating a dynamic optical effect when the patterns are overlapped.

It will, however, be appreciated that the orientations of the set of lines of the first and second Moire inducing patterns 41 and 42 may vary. For instance, if the sets of lines in each Moire inducing pattern 41, 42 in FIG. 7 were to extend diagonally parallel to the major axes of the elliptically shaped windows 4 and 5, then in the folded tag or label 40 shown in FIG. 8 the sets of lines in the first and second Moire inducing patterns 41 and 42 would be substantially perpendicular and a similar pattern of Talbot fringes would be produced.

It is also possible that different parts of each Moire inducing pattern 41, 42 may have different sets of lines extending in different directions so that more interesting Moire effects, possibly with Talbot fringes forming predetermined shapes or images, may be produced when the windows 4 and 5 are brought into register in the folded label.

The sets of lines forming the Moire inducing patterns 41 and 42 in the transparent windows 5 and 4 may be formed by embossing or printing the lines on the transparent, indicia-free portions of the substrate 2, for instance in an intaglio printing process or in a gravure or offset printing process.

In the exemplary embodiment of FIGS. 7 and 8, the first and second Moire inducing patterns 41 and 42 in the transparent windows 5 and 4 together constitute a verifying security device which does not require an external optical device or apparatus for verification. Further, while label incorporating a first Moire inducing pattern in a transparent window may be used to verify another Moire inducing pattern in a transparent window in another part of the same label, it may also be used to verify a Moire inducing pattern provided in a transparent window in another similar label. At least some of the exemplary embodiments of the invention, particularly the first, third and fourth exemplary embodiments, provide the general ability to verify a security device by viewing it through a window including verifying means which may be oriented at different angles in a flexible security label, such as a tag or label, for instance by twisting the label to create a dynamic variation in the observed effect, rather than a static effect produced by viewing in only one orientation. For example, the amount of light transmitted by polarising windows may vary when a tag or label is twisted or rotated. Where the verifying means is an optical lens, twisting of a security label may cause a distortion in an image forming the security device, and in the case of Moire inducing patterns, the Moire effect created by overlapping patterns may shift or experience a frequency change when the two Moire inducing patterns are twisted or rotated relatively to one another.

Referring to FIG. 11, there is shown a fifth exemplary embodiment of a label according to the present invention. The label 45 is similar to label of FIGS. 1 and 2 and corresponding reference numerals have been applied to corresponding parts. The label 45 is wrapped around an article in such a manner that the security device 4is verified or inspected through the said article. This embodiment concerns particularly recipients of all kinds, and preferably bottles.

Referring to FIGS. 12 and 13, there is shown a sixth exemplary embodiment of the present invention. In this embodiment a security label 46 bears a security device 4 (and for illustrative purpose an indicia 3) and a separate security tag 47 bears the security window 5. Both security label 46 and security tag 47 may comprise a flexible, sheet-like substrate of transparent plastic or cellulosic material, as illustrated in the other examples. The security tag 47 may be affixed to the article or provided separately.

In a further exemplary embodiment of the invention (not shown in the drawings), the security device 4 may be part of the article itself.

Referring to FIG. 13, the security tag of FIG. 12 is used to inspect or verify the security label of FIG. 12.

In a further exemplary embodiment of the invention (not shown in the drawings), there is provided a security label wherein a transparent essentially indicia free portion or “window” carries verifying means comprising a first portion of an image which, together with a security device in the form of a second portion of the image, forms a full image when the flexible security label is folded over itself to bring the first and second portions of the image into register to each other. The first portion of the image may be printed, coated, stamped or embossed on the window, and the second portion of the image may be provided either on another transparent essentially indicia-free window or on a part of the substrate covered by an opacifying coating. Preferably, the second portion of the image is hidden by an opacifying coating under reflected light, but is visible in transmitted light with the full image being visible in transmitted light when the label is folded over itself to bring the first and second portions of the image into register.

The embodiments of verifying security labels described above have the advantage that they may be formed relatively inexpensively in a one step or two step manufacturing process. The verification means and the security device in many instances can be formed in a single printing, stamping, coating and/or embossing step, such as an intaglio printing process. Also, the security tag or labels formed from a flexible substrate of transparent plastic and/or cellulosic material are strong and highly durable and are able to withstand many instances of bending, twisting, folding without significant wear.

It will be appreciated that various modifications and alterations may be made to the embodiments of the present invention described above without departing from the scope of the present invention. For instance two or more transparent windows including the same or different types of verification means may be provided at different locations on a single security tag or label for verifying a plurality of security devices at either locations transversely spaced on the security tag or label, provided however that each verifying means may be brought into register with a security device on the same or another verifying tag or label.

1. A self-authenticating arrangement comprising:
an article;
a label having a first portion fixed to said article, and a second portion movably mounted to said first portion so as to be movable between an authentication position superposed over said first portion and a non-authentication position;
a security device provided on one of said first and second portions of said label; and
a verification part provided on the other of said first and second portions of said label and which, when said second portion of said label is in said authentication position, is aligned in superposed relation over said security device to enable verification of authenticity of said article.

2. A self-authenticating arrangement according to claim 1, wherein
said verification part comprises a transparent part which, when said second portion of said label is in said authentication position, is aligned in superposed relation over said security device to enable viewing of said security device through said transparent part.

3. A self-authenticating arrangement according to claim 2, wherein
said transparent part comprises plastic material.

4. A self-authenticating arrangement according to claim 2, wherein
said transparent part comprises cellulosic material.

5. A self-authenticating arrangement according to claim 2, wherein
said transparent part comprises a magnifying lens.

6. A self-authenticating arrangement according to claim 5, wherein
said magnifying lens comprises a Fresnel magnifying lens.

7. A self-authenticating arrangement according to claim 5, wherein
said magnifying lens comprises a multiple micro-lens array.

8. A self-authenticating arrangement according to claim 5, wherein
said magnifying lens comprises a lenticular lens array.

9. A self-authenticating arrangement according to claim 5, wherein
said security device comprises microprinting.

10. A self-authenticating arrangement according to claim 2, wherein
said security device comprises microprinting.

11. A self-authenticating arrangement according to claim 2, wherein
said transparent part comprises a metameric filter.

12. A self-authenticating arrangement according to claim 11, wherein
said security device comprises a metameric image.

13. A self-authenticating arrangement according to claim 2, wherein
said security device comprises a metameric image.

14. A self-authenticating arrangement according to claim 2, wherein
said transparent part comprises a first polarization window.

15. A self-authenticating arrangement according to claim 14, wherein
said security device comprises a second polarization window.

16. A self-authenticating arrangement according to claim 2, wherein
said security device comprises a polarization window.

17. A self-authenticating arrangement according to claim 2, wherein
said transparent part comprises a first Moire-inducing pattern.

18. A self-authenticating arrangement according to claim 17, wherein
said security device comprises a second Moire-inducing pattern.

19. A self-authenticating arrangement according to claim 2, wherein
said security device comprises a Moire-inducing pattern.

20. A self-authenticating arrangement according to claim 1, wherein
said label comprises a single opacifying layer.

21. A self-authenticating arrangement according to claim 1, wherein
said label comprises an opacifying layer and a transparent layer.

22. A self-authenticating arrangement according to claim 1, wherein
said label comprises a transparent layer sandwiched between two opacifying layers.

23. A self-authenticating arrangement according to claim 1, wherein
said second portion of said label is foldable along a fold line relative to said first portion of said label.

24. A self-authenticating arrangement according to claim 1, wherein
said first portion of said label is adhered to said article.

25. A self-authenticating arrangement according to claim 1, wherein
said first and second portions of said label comprise first and second separate and discrete portions, said second portion being detachably mounted to said article.

26. A self-authenticating arrangement comprising:
an article;
a label mounted to said article;
a security device printed on one of said article and said label; and
a transparent portion provided on the other of said article and said label and through which said security device is viewable.

27. A self-authenticating arrangement according to claim 26, wherein
said label is adhered to said article with said transparent portion thereof aligned with said security device.

28. A self-authenticating arrangement according to claim 26, wherein
said label is fixed on said article such that said security device and said transparent part are aligned and said security device is viewable through said transparent part.

29. A self-authenticating arrangement according to claim 26, wherein
said transparent part comprises a magnifying lens.

30. A self-authenticating arrangement according to claim 29, wherein
said security device comprises microprinting.

31. A self-authenticating arrangement according to claim 26, wherein
said security device comprises microprinting.

32. A self-authenticating arrangement according to claim 26, wherein
said transparent part comprises a metameric filter.

33. A self-authenticating arrangement according to claim 32, wherein
said security device comprises a metameric image.

34. A self-authenticating arrangement according to claim 26, wherein
said security device comprises a metameric image.

35. A self-authenticating arrangement according to claim 26, wherein
said transparent part comprises a first polarization window.

36. A self-authenticating arrangement according to claim 35, wherein
said security device comprises a second polarization window.

37. A self-authenticating arrangement according to claim 26, wherein
said security device comprises a polarization window.

38. A self-authenticating arrangement according to claim 26, wherein
said transparent part comprises a first Moire-inducing pattern.

39. A self-authenticating arrangement according to claim 38, wherein
said security device comprises a second Moire-inducing pattern.

40. A self-authenticating arrangement according to claim 26, wherein
said security device comprises a Moire-inducing pattern.

41. A self-authenticating arrangement according to claim 26, wherein
said label is adhered to said article.
